(19) United States
(12) Patent Application Publication
(10) Pub. No.: US 2022/0299792 A1
(43) Pub. Date: Sep. 22, 2022

(54) LANYARD FOR SMART FRAMES AND MIXED REALITY DEVICES

(71) Applicant: Meta Platforms Technologies, LLC, Menlo Park, CA (US)

(72) Inventors: Barry David Silverstein, Kirkland, WA (US); Edgar Denis Auslander, Menlo Park, CA (US)

(21) Appl. No.: 17/205,888

(22) Filed: Mar. 18, 2021

(51) Int. Cl. G02C 3/00; G02B 27/01; G02C 11/00

(52) U.S. Cl. CPC G02C 3/006; G02B 27/0176; G02C 11/10; G02B 2027/0178; G02B 2027/0169

(57) ABSTRACT

A lanyard for securing a mixed reality device or a smart frame to a body of a user, is provided. The lanyard includes a first connector and a second connector, at least one of the first connector or the second connector configured to couple to a first leg and a second leg in the mixed reality device by at least one of a mechanical, a magnetic, or a chemical fitting. The lanyard also includes a cord separating the first connector from the second connector, and a power circuit configured to transfer a power between the mixed reality device and the lanyard through the first connector or the second connector. The cord includes an energy transfer component providing one of a digital signal to a processor in the mixed reality device, or the power from the power circuit to the processor of the mixed reality device.

### BACKGROUND

### Field

Embodiments as disclosed herein are related to the field of smart frames and mixed reality devices and accessories for safe, secure, and comfortable use thereof. More specifically, embodiments as disclosed herein are related to a lanyard to secure a mixed reality device or a smart frame to a body of a person (“user”) and prevent damage or loss of the device.

### Related Art

The use of virtual reality devices such as mixed reality devices or augmented reality devices is increasing due to new applications in entertainment as well as professional and creative industries. As these devices are wearable and typically untethered to stationary devices (e.g., computers), there is a need for providing accessories to secure the devices to the user's body to avoid damage or potential loss of the device. At the same time, it is desirable to securely and comfortably attach the device to the body of the user while allowing the user to have a hands-free experience with less concern about damage or loss of the device.

### SUMMARY

A lanyard for securing a mixed reality device or a smart frame to a body of a user is described. The lanyard includes a first connector and a second connector, at least one of the first connector or the second connector configured to couple to a first leg and a second leg in the mixed reality device by at least one of a mechanical, a magnetic, or a chemical fitting, a cord separating the first connector from the second connector, and a power circuit configured to transfer a power between the mixed reality device and the lanyard through the first connector or the second connector. The cord includes an energy transfer component providing one of a digital signal to a processor in the mixed reality device, or the power from the power circuit to the processor of the mixed reality device.

A mixed reality device is also described. The mixed reality device includes a frame, comprising a front holder and two legs, wherein the front holder supports one or more digital glasses, a memory circuit configured to store instructions, a processor circuit coupled to the memory circuit and configured to execute the instructions to cause the one or more digital glasses to provide a virtual image, an augmented audio or a sensor data to a user, and a lanyard mechanically coupled to the two legs in the frame. The lanyard includes a first connector and a second connector, at least one of the first connector or the second connector configured to couple to a first leg and a second leg in the mixed reality device by at least one of a mechanical, a magnetic, or a chemical fitting. The lanyard also includes a cord separating the first connector from the second connector by an adjustable distance greater than a circumference of a user body part, and a lanyard circuit configured to transmit a power or a digital signal between the mixed reality device and the lanyard through the first connector or the second connector. The cord comprises an energy transfer component providing one of a digital signal to a processor in the mixed reality device, or the power from the power circuit to the processor of the mixed reality device.

A smart frame device is also described. The smart frame includes a frame, comprising a front holder and two legs, wherein the front holder supports one or more glasses, an audio device, a memory circuit configured to store instructions, a processor circuit coupled to the memory circuit and configured to execute the instructions to cause the audio device to provide an augmented audio or a sensor data to a user, and a lanyard mechanically coupled to the two legs in the frame. The lanyard includes a first connector and a second connector, at least one of the first connector or the second connector configured to couple to a first leg and a second leg in the smart frame by at least one of a mechanical, a magnetic, or a chemical fitting. The lanyard also includes a cord separating the first connector from the second connector by an adjustable distance greater than a circumference of a user body part, and a power circuit configured to provide power to the smart frame through the first connector or the second connector. The cord comprises an energy transfer component providing one of a digital signal to a processor in the smart frame, or the power from the power circuit to the processor of the smart frame.

A non-transitory, computer-readable medium is further described. The medium stores instructions which, when executed by a processor in a computer, cause the computer to perform a method. The method includes providing an image, an audio, or a sensor data to one or more digital glasses in a mixed reality device or a smart frame worn by a user, wherein a lanyard secures the mixed reality device or smart frame to a body part of the user. The method also includes receiving, from a sensor in the lanyard, a datum associated with an environment of the user, and modifying the image, the audio or the sensor data in the mixed reality device or smart frame based on the datum received from the sensor on the lanyard. The method also includes capturing data from a user face or voice from at least one of a smart glass or an audio device in the mixed reality device or smart frame, and determining a user intention based on the data or voice, and providing a signal to an indicator in the lanyard, the signal being indicative of the user intention.

A system is also described. The system includes a means for storing instructions and a means for executing the instructions to cause the system to perform a method. The method includes providing an image, an audio, or a sensor data to one or more digital glasses in a mixed reality device or a smart frame worn by a user, wherein a lanyard secures the mixed reality device or smart frame to a body part of the user. The method also includes receiving, from a sensor in the lanyard, a datum associated with an environment of the user, and modifying the image, the audio or the sensor data in the mixed reality device or smart frame based on the datum received from the sensor on the lanyard. The method also includes capturing data from a user face or voice from at least one of a smart glass or an audio device in the mixed reality device or smart frame, and determining a user intention based on the data or voice, and providing a signal to an indicator in the lanyard, the signal being indicative of the user intention.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

FIG. 1A illustrates a mixed reality device with a lanyard, according to some embodiments.

FIG. 1B illustrates a smart frame with a lanyard, according to some embodiments.

FIG. 2 illustrates a lanyard for use with a mixed reality device or a smart frame, according to some embodiments.

FIGS. 3A-3B illustrate connectors coupling a lanyard to a mixed reality device or a smart frame using male/female fittings, according to some embodiments.

FIGS. 4A-4B illustrate connectors coupling a lanyard to a mixed reality device or a smart frame using a mechanical fitting, according to some embodiments.

FIG. 5 illustrates a user of a mixed reality device or smart frame having a lanyard coupled to a solar powered clothing, according to some embodiments.

FIG. 6 illustrates a user of a mixed reality device or smart frame having a lanyard including a back display and indicators, according to some embodiments.

FIG. 7 is a flowchart illustrating steps in a method for using a mixed reality device or smart frame secured to the user's body with a lanyard, according to some embodiments.

FIG. 8 is a block diagram illustrating a computer system configured to perform at least some of the steps in methods disclosed herein.

In the figures, like reference numerals refer to features and elements having like descriptions, except when indicated otherwise.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Embodiments as disclosed herein include the use of a lanyard as an accessory to one of multiple types of wearable augmented reality (A/R) or virtual reality (V/R) devices. In A/R devices, the digitally generated image is superimposed, at least partially, to an image of the environment transmitted optically to the user (e.g., via lenses, prisms, waveguides, and the like). In V/R devices, the whole or a large portion of the user view includes a digitally generated image. Some of these wearable devices may include audio-A/R devices such as smart frames, which may not include a digital display, but include audio assistance, cameras, and sensors to determine a position of the frame on the user's head, and the like. In some embodiments, a wearable device using a lanyard as disclosed herein may include smart glasses such as optical see-through monocular/binocular devices configured for two-dimensional (2D) or three-dimensional (3D) display (typically with a low field of view—FoV—of less than about 40°). In some embodiments, a wearable device using a lanyard as disclosed herein may include a full A/R optical see-through binocular, providing a full 3D display with medium to large FoV (e.g., greater than 40°). In some embodiments, a wearable device using a lanyard as disclosed herein may include a mixed reality device having a video see-through, with binocular, full 3D, and medium to large FoV. In some embodiments, a wearable device using a lanyard as disclosed herein may include a virtual reality device having binocular, full 3D, and large FoV.

Digital glasses (“smart” glasses) in mixed reality devices as disclosed herein have a functionality beyond fixed vision correction, and are wearable optical devices that provide digital vision correction, sensing, brain interface, and audio to users, among other functionalities. In some embodiments, digital glasses provide a mixed reality experience to the user, including a more complete view of the surroundings with the aid of displays configured to project digitally generated or improved images, icons, and information.

As use of mixed reality devices, smart frames, and other wearable headsets increases by individuals, users are wearing these devices in more places and in different circumstances than before. Accordingly, it has become desirable to add accessories to these devices to enhance the comfort, performance, the enjoyment, and safety of their use in many different environments. One common occurrence in different form factors for mixed reality devices and smart frames, namely headsets, glasses, and the like, is that they may become dislodged from the user's head, and thereafter fall, break, or simply cause undesirable interruption in the enjoyment of the device. In some cases, a user may drop the device out of reach (e.g., into a void, or a water reservoir), causing irretrievable loss of the device, which may have substantive personal and financial value to the user. Embodiments as disclosed herein provide a lanyard to secure a mixed reality device or a smart frame to the user's body or clothing and resolve the above problem. The lanyard may be used as a replaceable or a permanent accessory to mixed reality devices such as A/R glasses (“smart” glasses) or V/R headsets.

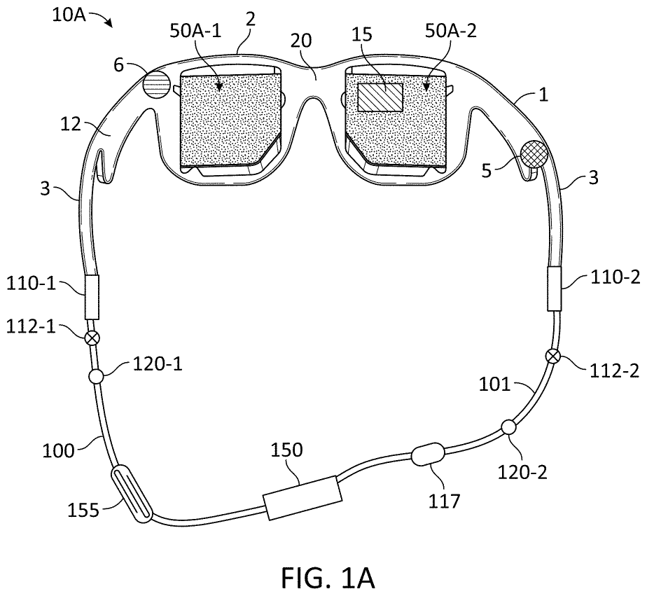

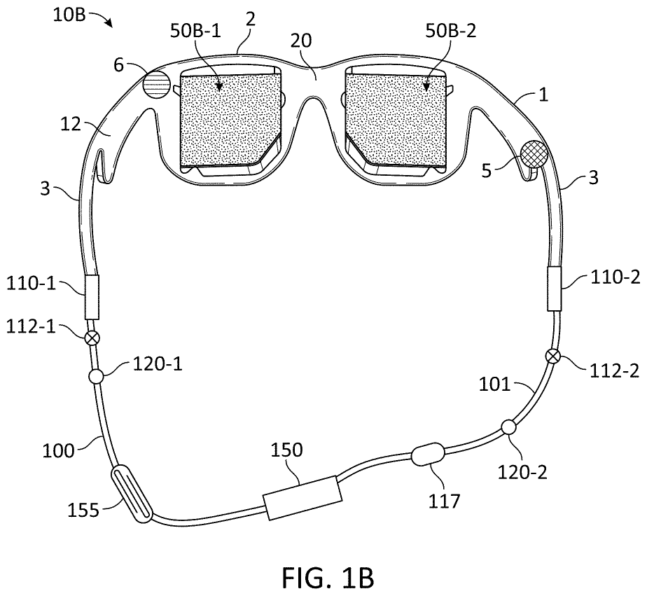

FIGS. 1A-1B illustrate a mixed reality device 10A and a smart frame 10B including a lanyard 100, according to some embodiments. Mixed reality device 10A and smart frame 10B may include a frame 1, having a front holder 2, two legs 3, a speaker/microphone 5, and a sensor 6. Legs 3 may include any mechanical extension of frame 1, such as protrusions. In some embodiments, front holder 2 may be configured to support mixed reality device 10A over the bridge of the user's nose, or another portion of the user's face. In some embodiments, mixed reality device 10A or smart frame 10B may hang over the top of the user's head. Speaker/microphone 5 may provide audio enhancement of the view through mixed reality device 10A and smart frame 10B. Sensor 6 may include a back-facing camera or any other device (e.g., ultrasound emitter, or infrared light source) configured to detect the user's facial features and assess a position of mixed reality device 10A or smart frame 10B relative to the user's face or head.

In mixed reality device 10A, front holder 2 supports one or more digital glasses 50A-1 and 50A-2 (hereinafter, collectively referred to as “digital glasses 50A”) and at least one display 15 optically coupled with one of digital glasses 50. In smart frame 10B, front holder 2 supports one or more glasses 50B-1 and 50B-2 (hereinafter, collectively referred to as “glasses 50B”). In some embodiments, glasses 50B in smart frame 10B may be optical glasses without a display for providing an enhanced reality view (A/R, V/R, or any combination thereof) to the user. In some embodiments, mixed reality device 10A or smart frame 10B may provide a digital vision correction to the user. For example, in some embodiments a digital vision correction may include electrically adjusting the optics in mixed reality device 10A or smart frame 10B to a fixed position to correct for a user's specific vision prescription. In yet other embodiments, mixed reality device 10A or smart frame 10B may actively (e.g., in real time) correct the prescription in accordance with a focal distance of the user (cf. U.S. Ser. No. 10/881,287B1, to Andrew John Ouderkirk, et al.).

Mixed reality device 10A and smart frame 10B also include a memory circuit 12 configured to store instructions, and a processor circuit 20 coupled to memory circuit 12 and configured to execute the instructions to cause display 15 to provide a virtual image superimposed to a field of view of digital glasses 50A, or to provide an audio signal to the user of smart frame 10B (e.g., through speaker/microphone 5). In some embodiments, lanyard 100 is mechanically coupled to legs 3.

Lanyard 100 may include a first connector 110-1 and a second connector 110-2 (hereinafter, collectively referred to as “connectors 110”) to mechanically secure lanyard 100 with legs 3. In addition to providing a mechanical coupling between lanyard 100 and mixed reality device 10A, connectors 110 can transmit electric signals for data, and power. For example, in some embodiments, connectors 110 may include a universal serial bus (USB) connector that could be lockable (e.g., USB-C connector, and the like). In some embodiments, lanyard 100 may include one, two, or multiple connector ports 112 in addition to connectors 110. For example, connector ports 112-1 and 112-2 may include discreet ports or outputs for data, power, audio (coupled to an earbud that the user may be wearing), video, and the like.

In some embodiments, a cord 101 separates first connector 110-1 from second connector 110-2 by an adjustable distance greater than a circumference of a user body part (e.g., the user's neck, head, waist, wrist, ankle, arm, leg, and the like). Connectors 110 may be permanent connectors, or may be replaceable connectors, so that the user may attach or detach lanyard 100 at will. Connectors 110 may include a mechanical connection (e.g., a clip, latch, screw, bayonet connector, Snap-On connectors, and the like), a magnetic connection, or a chemical connection via an adhesive (e.g., a contact or pressure adhesive, and the like).

In some embodiments, lanyard 100 includes a power circuit 150 configured to provide power to memory circuit 12 and processor circuit 20 through connectors 110. Power circuit 150 may include a battery, a solar cell, or any other circuit configured to gather energy from the environment and convert it to electrical power to provide to mixed reality device 10A or smart frame 10B.

In some embodiments, mixed reality device 10A may provide to display 15 an image or video stored in a memory included in lanyard 100, or streamed wirelessly or via a cable (e.g., a USB port and the like, through cord 101).

Lanyard 100 may also include one or more sensors 120-1 and 120-2 (or even more, hereinafter, collectively referred to as “sensors 120”). In some embodiments, sensors 120 are distal from connectors 110. In some embodiments, cord 101 includes an electrical wire providing a digital signal from sensors 120 or a power signal from power circuit 150 to memory circuit 12 and to processor circuit 20. In some embodiments, at least one or more of sensors 120 may wirelessly communicate with processor circuit 20, with another sensor 120 in lanyard 100, or with another sensor in mixed reality device 10A. Sensors 120 may include offload sensors, or additional sensors such as microphones and the like, to provide a stereophonic, 360-degree sound experience for the user. For example, sensors 120 may include a microphone that provides surrounding sound to processor 20, which may be configured to perform noise cancelation, and to pinpoint a source of a sound, in combination with other microphones in mixed reality device 10A or smart frame 10B.

Sensors 120 may be complementary to existing sensors in mixed reality device 10A, or be independent from them. Accordingly, the availability of relatively large space with fewer comfort limitations in lanyard 100 may enable the implementation of more powerful and sophisticated sensors 120 that enhance substantially the environmental awareness for the user.

In some embodiments, lanyard 100 may include complementary electronics 117 to enhance computing capabilities in support of memory circuit 12 and processor circuit 20. Accordingly, complementary electronics 117 may enable the enhancement of processing and memory capabilities in mixed reality device 10A or smart frame 10B (e.g., the use of a more powerful and sophisticated memory circuit 12 or processor circuit 20). This may enable mixed reality device 10A or smart frame 10B to store, process, and project to the user higher quality video.

In some embodiments, complementary electronics 117 may include a brain computer interface (BCI) circuit in contact with different areas in the back of the user's head. This feature may further enhance the hands-free experience of the user of mixed reality device 10A or smart frame 10B, thus providing a better and safer experience to the user and those in the surrounding area.

In some embodiments, sensors 120 may include additional cameras to provide a better view of the user environment, for safety (e.g., rearview for A/R as a safety feature, such as for bicycle riding). Accordingly, the cameras may provide a back view of the user to processor circuit 20, which may then process the image and provide at least a partial view for the user on display 15.

Sensors 120 may also include health sensors to monitor a vital sign from the user (e.g., heart rate, breathing rate, body temperature, and the like). In some embodiments, processor circuit 20 may use the signals from a vital sign for the user to identify a user reaction to an image projected on display 15. For example, sensors 120 may provide an accelerated heart rhythm for the user, or a higher breathing frequency, indicative of user excitement or an overly sensitive reaction to the image in display 15.

In some embodiments, sensors 120 may include depth and other positional sensing (e.g., LIDAR, radar, and the like). For example, in some embodiments, one or more of sensors 120 may indicate to the user the presence of an environmental hazard, such as a wall, a hole in the ground, another person, animal, or object in the vicinity of the user, and the like. In addition, sensors 120 may estimate the distance to the user of a given obstacle, architectural feature, car or vehicle, and the like. Accordingly, in some embodiments, sensors 120 may be configured to activate an alarm (via audio or visually through display 15) when the distance becomes shorter than a pre-selected threshold, or when processor 20 predicts that the user may crash into the obstacle (or the object or vehicle will crash the user from behind) within a pre-selected amount of time. For example, in some embodiments, lanyard 100 and mixed reality device 10A or smart frame 10B may be used in sporting applications (e.g., parachuting, paragliding, skydiving, or together with a wingsuit), and sensors 120 may provide indications and warnings to the user about height, and proximity of buildings or geographical features in the landscape.

In some embodiments, sensors 120 may include inertial measurement units (IMUs) such as accelerometers, gyroscopes, and the like. For example, an accelerometer may indicate to the user that lanyard 100 rests safely on the user's neck, or it moves together with the user's body, in synchrony, or not.

Sensors 120 may also include a tension sensor, to measure the degree of tension in cord 101. For example, when mixed reality device 10A or smart frame 10B falls form the user's face, it hangs form the user's neck tensioning lanyard 100. Accordingly, in some embodiments, sensors 120 may determine that mixed reality device 10A is hanging from the user's neck. Whether this configuration is attained on purpose or by accident, processor circuit 20 may turn mixed reality device 10A or smart frame 10B ‘off’ or to ‘sleep’ mode, when sensors 120 detect that mixed reality device 10A or smart frame 10B is no longer on the face of the user.

Accordingly, sensors 120 may be configured to determine whether mixed reality device 10A or smart frame 10B has been dropped by the user, and if it has, whether it has fallen into a water reservoir, and to what depth. Accordingly, sensors 120 or processor circuit 20 may be configured to turn mixed reality device 10A or smart frame 10B ‘off’ when there is an indication that the device has been dropped, or will likely be dropped by the user. In some embodiments, and taking advantage of the extended length of cord 101, lanyard 100 may include an expanded radio-frequency (RF) antenna 155 to add to the RF capabilities of mixed reality device 10A or smart frame 10B. For example, lanyard 100 offers a natural extension for an RF antenna that may be used to broaden the RF bandwidth of mixed reality device 10A or smart frame 10B, and broaden its tuning capacity (e.g., by combining multiple RF antennas). Accordingly, a better RF tuning capability may enhance the electromagnetic interference (EMI) removal from wireless signals used by mixed reality device 10A or smart frame 10B.

In some embodiments, at least one of sensors 120 includes a haptic sensor configured to provide a posture information to processor circuit 20. With the ability for sensors 120 to rest on the neck of the wearer (or a bit below) and capture posture information, the user would be advised to correct a posture. For example, sensors 120 may detect either a vibration and processor circuit 20 may provide an image to display 15, encouraging the user to stand straight or improve their posture. In some embodiments, a sensor 120 provides back posture information that processor circuit 20 combines with an IMU sensor in mixed reality device 10A or smart frame 10B to provide head posture, further enhancing health benefits with sensor-fusion processing by processor circuit 20.

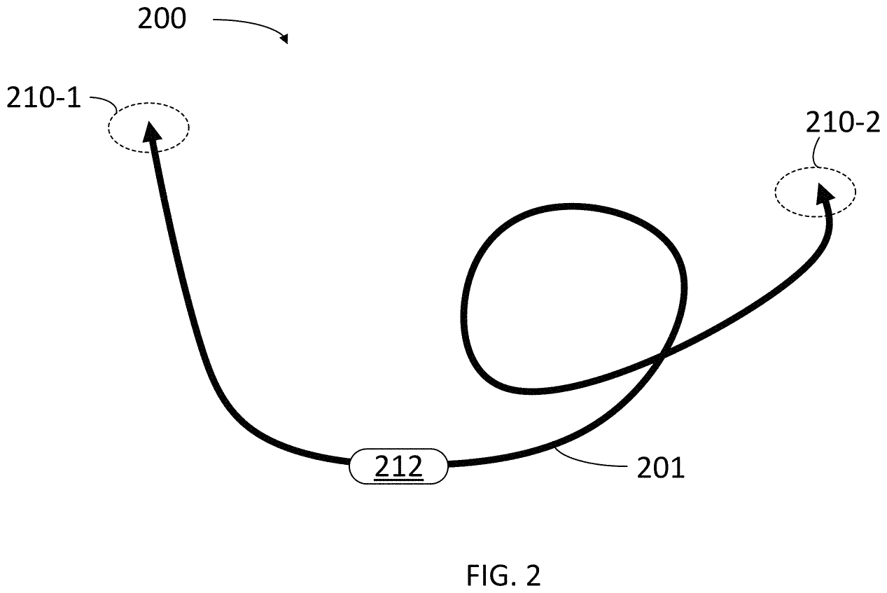

FIG. 2 illustrates a lanyard 200 with a cord 201 for use with a mixed reality device or a smart frame, according to some embodiments. Connectors 210-1 and 210-2 (hereinafter, collectively referred to as “connectors 210”) may be as described above (cf. connectors 110 in lanyard 100). In some embodiments, cord 201 is made of a stretchable fabric configured to electrically insulate the electrical wire from an electromagnetic interference to avoid electrical shock to the user, or a short circuit with the electronics in the mixed reality device. It is also desirable that the material of cord 201 be comfortable for use, and aesthetically pleasing. In some embodiments, cord 201 includes a material such as a woven fabric, a polymer, or a rubberized or plastic foam material that provides a cavitation force to enable flotation of the mixed reality device, in case it falls in a body of water.

In some embodiments, cord 201 includes an energy transfer component providing one of a digital signal from the sensor to a processor in the mixed reality device (e.g., processor circuit 20), or the power from a power circuit (e.g., power circuit 150) to the processor of the mixed reality device. In some embodiments, the energy transfer component includes an electrical conductor (e.g., a copper wire, or any other electrically conducting wire, filament, mesh, or fabric) configured to provide the power from the power circuit. In some embodiments, the energy transfer component in cord 201 may include an optical guide (e.g., a single mode or multimode optical fiber, crystal, waveguide, or any combination thereof) configured to provide a high speed digital signal from the sensor to the processor in the mixed reality device.

In some embodiments, cord 201 further includes one or more flotation components 212, configured to provide a cavitation force to the mixed reality device in a body of water. The area that lanyard 200 contacts the body of the user may include sensitive parts of the neck and head of the user, and some embodiments may include selected materials and form factors to provide a comfortable and secure contact with the user body.

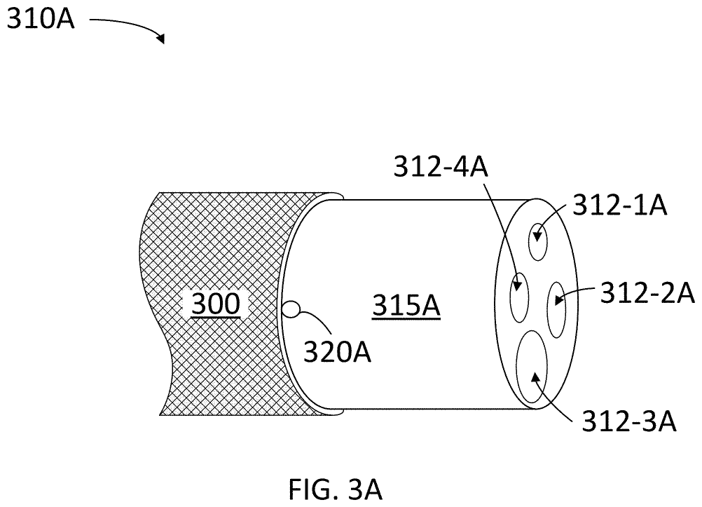

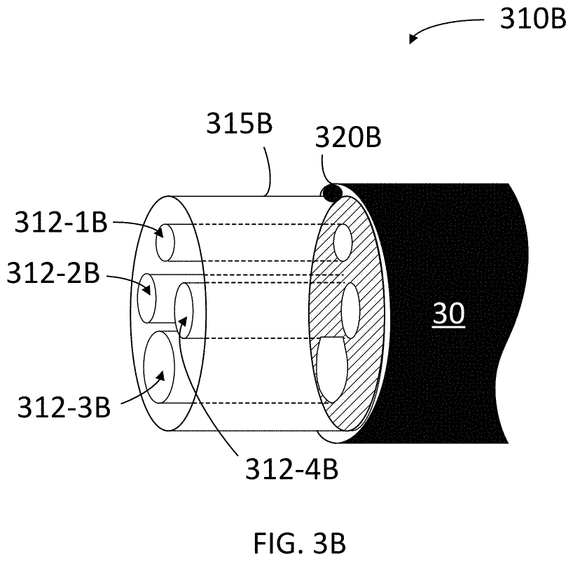

FIGS. 3A-3B illustrate connectors 310A and 310B (hereinafter, collectively referred to as “connectors 310”) coupling a lanyard 300 to a mixed reality device or smart frame 30, according to some embodiments. Connector 310A includes an interface 315A terminating lanyard 300. Connector 310B includes an interface 315B terminating a leg or other portion of a frame of mixed reality device 10A. Interface 315A may include fittings 312-1A, 312-2A, 312-3A, and 312-4A (hereinafter, collectively referred to “fittings 312A”). Interface 315B may include fittings 312-1B, 312-2B, 312-3B, and 312-4B (hereinafter, collectively referred to “fittings 312B”). Interfaces 315A and 315B will be collectively referred to, hereinafter, as “interfaces 315.” Fittings 312A and 312B will be collectively referred to, hereinafter, as “fittings 312.”

Fittings 312 may have different shapes and form factors, such as a male-female configuration. Some embodiments may include fittings 312A being female and fittings 312B being male. Some embodiments may include some of fittings 312A being male and some of fittings 312A being female, with the corresponding configuration for fittings 312B. Accordingly, the digital interconnects provided by fittings 312 transmit electrical pulses (e.g., signals and power) between lanyard 300 and mixed reality device or smart frame 30.

Interfaces 315 may form a mechanical connection between lanyard 300 and mixed reality device 10A, e.g., by virtue of a pressure fitting amongst fittings 312. In some embodiments, in addition to a pressure fitting, interfaces 315 may include a magnetized material (e.g., a metal or a polymer with embedded magnetized grains, or stripes) that provides a magnetic coupling between lanyard 300 and mixed reality device or smart frame 30. In some embodiments, interfaces 315 may include sensors 320A and 320B (hereinafter, collectively referred to as “sensors 320”). Accordingly, sensors 320 may provide a signal to a processor circuit in mixed reality device or smart frame 30 (e.g., processor circuit 20) indicative of a connect/disconnect event in connectors 310. Sensors 320 may be contact sensors, pressure sensors, magnetic sensors, capacitive sensors, or optical sensors.

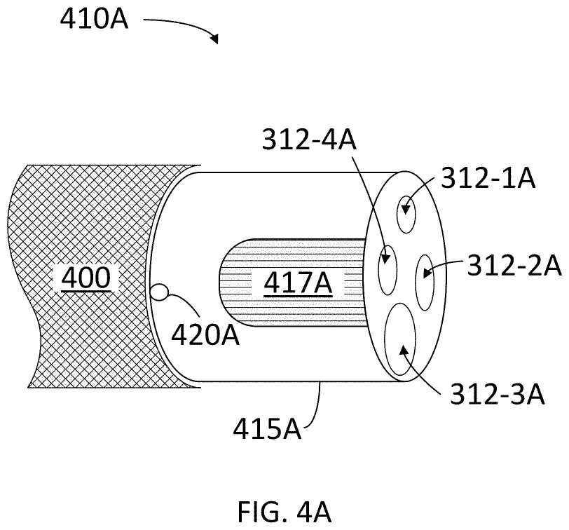

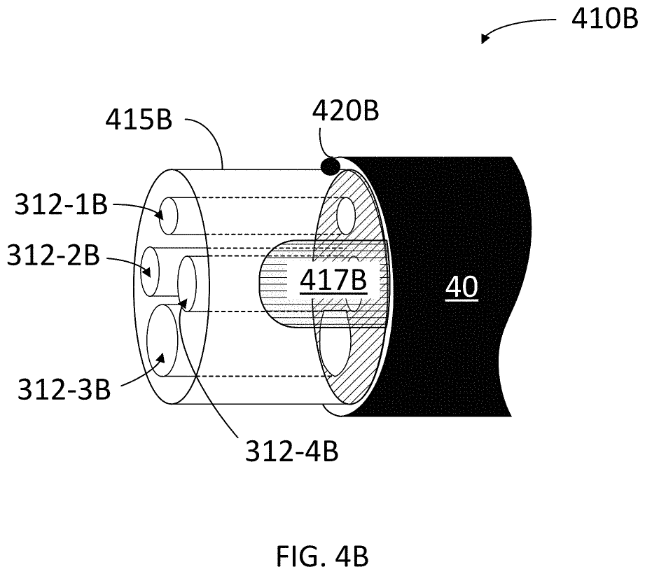

FIGS. 4A-4B illustrate connectors 410A and 410B (hereinafter, collectively referred to as “connectors 410”) coupling a lanyard 400 to a mixed reality device or smart frame 40, according to some embodiments. Connector 410A includes an interface 415A terminating lanyard 400. Connector 410B includes an interface 415B terminating a leg or other portion of a frame of mixed reality device or smart frame 40. Interface 415A may include fittings 312A, and a clip 417A. Interface 415B may include fittings 312B, and a clip 417B that matches clip 417A (hereinafter, collectively referred to as “clips 417”). Interfaces 415A and 415B will be collectively referred to, hereinafter, as “interfaces 415.”

Clips 417 may include metal clips, buttons, latches, or mechanical clips that secure interfaces 415 firmly together. In some embodiments, clips 417 may include a chemical bond, such as a layer of viscoelastic or tacky polymer, or a pressure sensitive glue layer. Accordingly, clips 417 may provide a permanent or a releasable interconnect between interfaces 415. In some embodiments, interfaces 415 may include sensors 420A and 420B (hereinafter, collectively referred to as “sensors 420”). Accordingly, sensors 420 may provide a signal to a processor circuit in mixed reality device or smart frame 40 (e.g., processor circuit 20) indicative of a connect/disconnect event in connectors 410. Sensors 420 may be contact sensors, pressure sensors, magnetic sensors, capacitive sensors, or optical sensors.

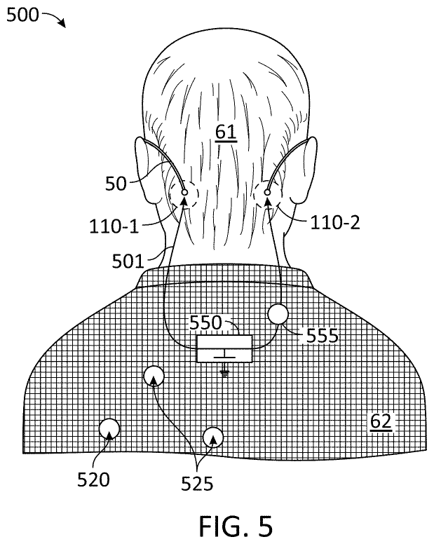

FIG. 5 illustrates a user 61 of a mixed reality device or smart frame 50 having a lanyard 500 coupled to a user clothing 62, according to some embodiments. In some embodiments, user clothing 62 may include a solar powered fabric or motion powered fabric. Lanyard 500 is coupled to mixed reality device or smart frame 50 via connectors 110. A power circuit 550 is configured to couple an electromotive force provided by powered fabric in clothing 62 into an electrical connection in cord 501 to provide power to mixed reality device or smart frame 50. In some embodiments, contact 555 is configured to attach lanyard 500 to other accessories in the user's clothing 62. In some embodiments, lanyard 500 and clothing 62 is a shirt such that contact 555 may be magnetically coupled to a tag on the back of the shirt. In some embodiments, clothing 62 may include light sensitive fabric to provide power to lanyard 500 and subsequently to mixed reality device or smart frame 50. In some embodiments, clothing 62 may collect or gather electrical power through motion.

In some embodiments, clothing 62 may include embedded health sensors 520 (e.g., to detect cardiorespiratory cycles, a temperature measurement, a sweat monitor, and the like). In some embodiments, clothing 62 may include sensors 525 that feed data to a processor in mixed reality device or smart frame 50 via a direct electrical connection through a contact 555. Sensors 525 may include a plurality of sensors configured to detect a posture of user 61, and even a bodily motion or gesture. The ability to couple sensors 525 through lanyard 500 may substantially reduce the requirements for wireless bandwidth in the electronics of mixed reality device or smart frame 50. In some embodiments, sensors 525 may include haptic sensors and IMUs, optionally enhanced with sensor fusion for more precision, lower power consumption, and/or to provide more context (e.g., whether the user is running or sitting). For example, the haptic part of a sensor 525 may provide a vibration that would communicate via haptic feedback (vibration) to user 61 to modify her/his posture to stand straight. In some embodiments, a sensor 525 may include an IMU enhanced with sensor fusion.

Contact 555 may include a direct electrical coupling between a conductor in lanyard 500 and clothing 62, or it may be a near-field contact (NFC) device inductively coupling a conductor in lanyard 500 with health sensors 520, haptic sensors 525, or any other portion of clothing 62.

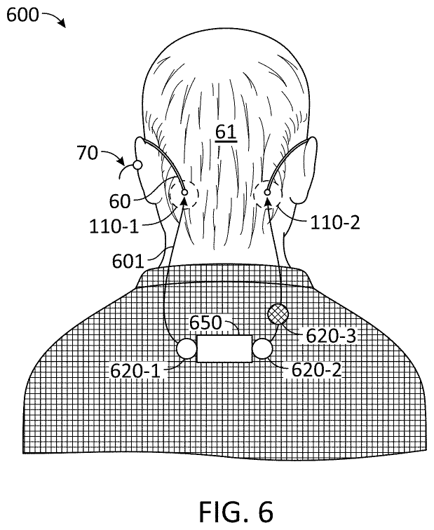

FIG. 6 illustrates a user 61 of a mixed reality device or smart frame 60 coupled to a lanyard 600 through connectors 110. Lanyard 600 includes a back display 650 and indicators 620-1 and 620-2, according to some embodiments. In some embodiments, back display 650 may include an LCD/display that turns signals/blinking lights (e.g., indicators 620) based on eye tracking capabilities in mixed reality device or smart frame 60, or directions from a map application running on display 15. In some embodiments, back display 650 may include a partial display from an application running on mixed reality device or smart frame 60 via an electrical connection in cord 601. Accordingly, back display 650 may guide a person in the background as to what to expect or predict user 61 may do. In some embodiments, lanyard 600 includes a microphone 620-3 that collects a background sound, so that a processor circuit in mixed reality device or smart frame 60 provides a stereophonic sound signal to a speaker 70 for user 61, based on the background sound. Speaker 70 may be an earbud wirelessly coupled with mixed reality device or smart frame 60.

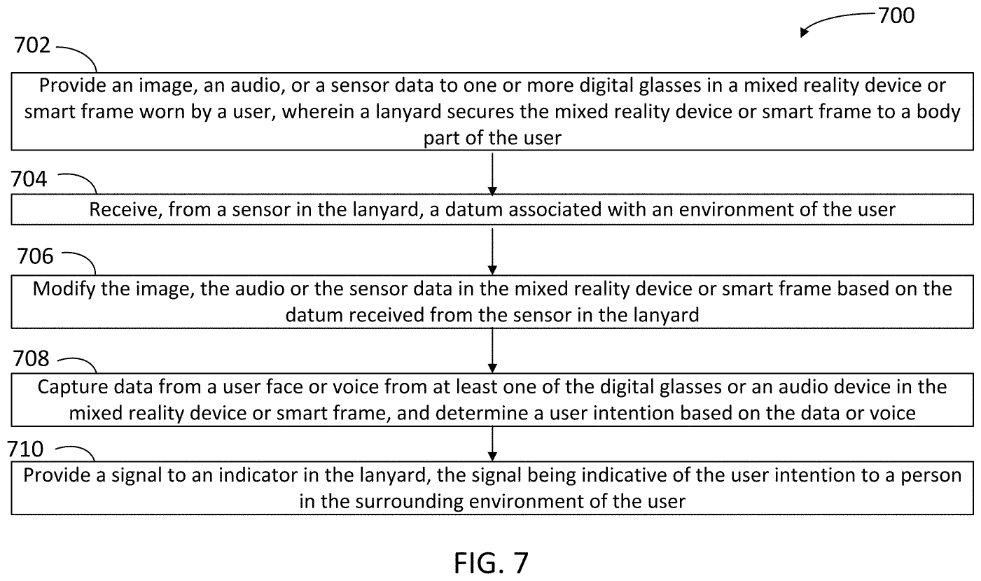

FIG. 7 is a flowchart illustrating steps in a method 700 for using a mixed reality device or smart frame secured to the user's body with a lanyard, according to some embodiments (cf. mixed reality devices and smart frames 10A, 10B, 30, 40, 50, and 60, and lanyards 100, 200, 300, 400, 500, and 600). At least one or more of the steps in method 700 may be performed by a processor circuit executing instructions stored in a memory circuit (cf. memory circuit 12 and processor circuit 20). The processor circuit and the memory circuit may receive data provided by one or more sensors in the lanyard, and may provide signals and data to indicators and displays in the lanyard (e.g., sensors 120, indicators 620, and display 650) via electrical interconnects from interfaces in connectors coupling the lanyard to the mixed reality device or smart frame (e.g., connectors 110, 310, and 410, and interfaces 315 or 415). The one or more sensors may include a haptic sensor, a tension sensor, an IMU sensor, a microphone, or a camera, consistent with the present disclosure. The indicators may include a speaker, a display, or an LED, according to the present disclosure. Methods consistent with the present disclosure may include at least one or more of the steps in method 700 performed in any order, simultaneously, quasi-simultaneously, or overlapping in time.

Step 702 includes providing an image, an audio, or a sensor data to one or more digital glasses in a mixed reality device or a smart frame worn by a user, wherein the lanyard secures the mixed reality device or smart frame to a body part of the user.

Step 704 includes receiving, from a sensor in the lanyard, a datum associated with an environment of the user. The datum may include a surrounding noise or sound, a back image, or an indication that the mixed reality device or smart frame has shifted or fallen from a secure position. In some embodiments, the datum may include a haptic signal indicative of an undesirable posture of the user. In some embodiments, step 704 includes receiving a power signal from a power circuit in the lanyard. The power circuit may include a battery, a solar cell, or a coupler receiving the power signal from an electromotive force generated from the user's clothing.

Step 706 includes modifying the image, the audio or a sensor data in the mixed reality device or smart frame based on the datum received from the sensor in the lanyard. In some embodiments, step 706 may include providing at least a partial view of a back camera in the lanyard to the user, in the display. In some embodiments, step 706 may include providing in the display an indication that at least one of the connectors mechanically coupling the lanyard to the mixed reality device has been disconnected.

Step 708 includes capturing data from a user face or voice from at least one of the digital glasses or an audio device in the mixed reality device or smart frame, and determining a user intention based on the data or voice from the user. In some embodiments, step 708 includes capturing an image of a user face from at least one of the digital glasses, and determining a user intention based on the image of the user face. In some embodiments, step 708 includes capturing an eye motion of the user to determine a vergence (the simultaneous movement of the pupils of the eyes toward or away from one another during focusing—e.g., on an object of interest—) or a saccade motion. Accordingly, step 708 includes identifying a focus of attention of the user based on the vergence, the saccade motion, an eye synchronicity, and the like.

Step 710 includes providing a signal to an indicator in the lanyard, the signal being indicative of the user intention to a person in the surrounding environment of the user.

### Hardware Overview

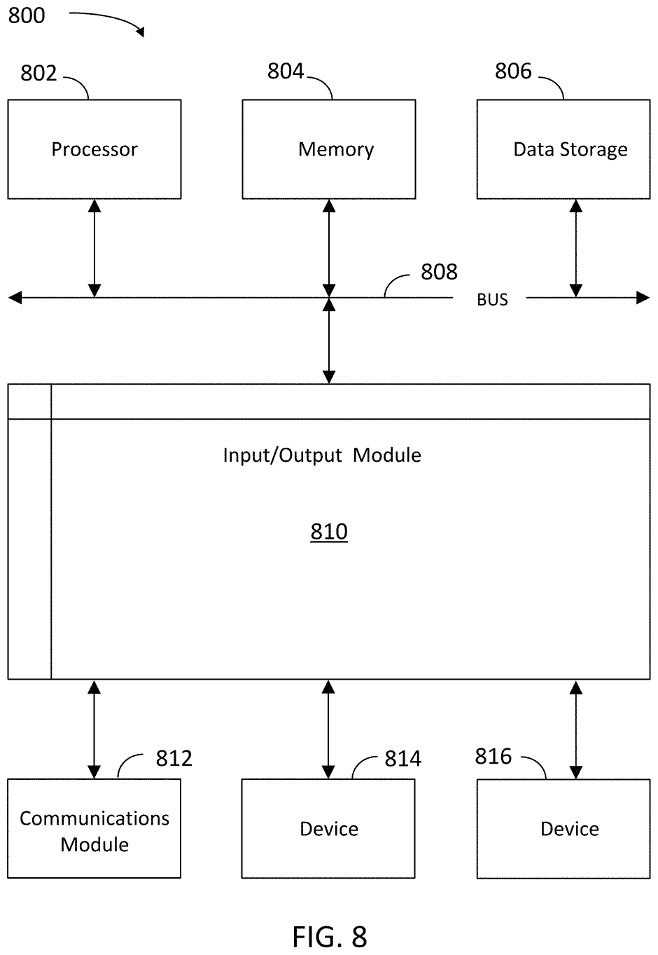

FIG. 8 is a block diagram illustrating an exemplary computer system 800 with which the mixed reality device and the lanyard of FIGS. 1-6 (e.g., mixed reality devices or smart frames 10A, 10B, 30, 40, 50, and 60, and lanyards 100, 200, 300, 400, 500, and 600), and the method of FIG. 7 can be implemented. In certain aspects, the computer system 800 may be implemented using hardware or a combination of software and hardware, either in a dedicated server, or integrated into another entity, or distributed across multiple entities.

Computer system 800 includes a bus 808 or other communication mechanism for communicating information, and a processor 802 (e.g., processor circuit 20) coupled with bus 808 for processing information. By way of example, the computer system 800 may be implemented with one or more processors 802. Processor 802 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 800 can include, in addition to hardware, a code that creates an execution environment for the computer program in question, e.g., code that constitutes processor firmware, a protocol stack, a database management system, an operating system, or a combination of one or more of them stored in an included memory 804 (e.g., memory circuit 12), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 808 for storing information and instructions to be executed by processor 802. The processor 802 and the memory 804 can be supplemented by, or incorporated in, a special purpose logic circuitry.

The instructions may be stored in the memory 804 and implemented in one or more computer program products, i.e., one or more modules of computer program instructions encoded on a computer-readable medium for execution by, or to control the operation of, the computer system 800, and according to any method well-known to those skilled in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 804 may also be used for storing temporary variable or other intermediate information during execution of instructions to be executed by processor 802.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 800 further includes a data storage device 806 such as a magnetic disk or optical disk, coupled to bus 808 for storing information and instructions. Computer system 800 may be coupled via input/output module 810 to various devices. Input/output module 810 can be any input/output module. Exemplary input/output modules 810 include data ports such as USB ports. The input/output module 810 is configured to connect to a communications module 812. Exemplary communication modules 812 include networking interface cards, such as Ethernet cards and modems. In certain aspects, input/output module 810 is configured to connect to a plurality of devices, such as an input device 814 and/or an output device 816. Exemplary input devices 814 include a keyboard and a pointing device, e.g., a mouse or a trackball, by which a user can provide input to the computer system 800. Other kinds of input devices 814 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 816 include display devices, such as an LCD (liquid crystal display) monitor, for displaying information to the user.

According to one aspect of the present disclosure, mixed reality device 10A can be implemented using a computer system 800 in response to processor 802 executing one or more sequences of one or more instructions contained in memory 804. Such instructions may be read into memory 804 from another machine-readable medium, such as data storage device 806. Execution of the sequences of instructions contained in main memory 804 causes processor 802 to perform the process steps described herein. One or more processors in a multi-processing arrangement may also be employed to execute the sequences of instructions contained in memory 804. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communication modules can be, for example, modems or Ethernet cards.

Computer system 800 can include clients and servers. A client and server are generally remote from each other and typically interact through a communication network. The relationship of client and server arises by virtue of computer programs running on the respective computers and having a client-server relationship with each other. Computer system 800 can be, for example, and without limitation, a desktop computer, laptop computer, or tablet computer. Computer system 800 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 802 for execution. Such a medium may take many forms, including, but not limited to, non-volatile media, volatile media, and transmission media. Non-volatile media include, for example, optical or magnetic disks, such as data storage device 806. Volatile media include dynamic memory, such as memory 804. Transmission media include coaxial cables, copper wire, and fiber optics, including the wires that include bus 808. Common forms of machine-readable media include, for example, floppy disk, flexible disk, hard disk, magnetic tape, any other magnetic medium, CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A lanyard for securing a mixed reality device or a smart frame to a body of a user, comprising:
a first connector and a second connector, at least one of the first connector or the second connector configured to couple to a first leg and a second leg in the mixed reality device by at least one of a mechanical, a magnetic, or a chemical fitting;
a cord separating the first connector from the second connector; and
a power circuit configured to transfer a power between the mixed reality device and the lanyard through the first connector or the second connector, wherein:
the cord comprises an energy transfer component providing one of a digital signal to a processor in the mixed reality device, or the power from the power circuit to the processor of the mixed reality device.

2. The lanyard of claim 1, wherein the energy transfer component comprises an electrical conductor configured to provide the power from the power circuit.

3. The lanyard of claim 1 further comprising a sensor, wherein the energy transfer component comprises an electrical conductor configured to provide a signal from the sensor to the processor of the mixed reality device.

4. The lanyard of claim 1, wherein the energy transfer component comprises an optical guide configured to provide a high speed digital signal from a sensor in the cord to the processor in the mixed reality device.

5. The lanyard of claim 1, further configured for attachment to other wearable accessories of the user comprising one of a magnetic attachment, and an electric attachment to a fabric worn by the user.

6. The lanyard of claim 1, wherein the first connector and the second connector comprise one of:
a latch,
a button,
a pressure fitting interconnect to mechanically secure the cord to the mixed reality device, or
a releasable magnetic interconnect to mechanically secure the cord to the mixed reality device.

7. The lanyard of claim 1, wherein the cord further comprises a flotation component configured to provide a cavitation force to the mixed reality device in a body of water.

8. The lanyard of claim 1, further comprising at least one sensor distal from the first connector and the second connector, wherein the at least one sensor comprises one of:
a haptic sensor configured to provide a posture information to the processor in the mixed reality device,
an inertial measurement unit configured to measure an acceleration of the lanyard and provide the acceleration of the lanyard to the processor,
a microphone, wherein the digital signal comprises a background sound for the user,
a health monitoring sensor, or
a chemical sensor.

9. The lanyard of claim 1, wherein the cord is configured to hold the mixed reality device to a user's neck, further comprising a back looking camera, wherein the digital signal comprises a back view for the user captured with the back looking camera.

10. The lanyard of claim 1, wherein the power circuit is configured to capture an electromotive force from a contact with a user clothing.

11. A mixed reality device, comprising:
a frame, comprising a front holder and two legs, wherein the front holder supports one or more digital glasses;
a memory circuit configured to store instructions;
a processor circuit coupled to the memory circuit and configured to execute the instructions to cause the one or more digital glasses to provide a virtual image, an augmented audio or a sensor data to a user; and
a lanyard mechanically coupled to the two legs in the frame, the lanyard comprising:
a first connector and a second connector, at least one of the first connector or the second connector configured to couple to a first leg and a second leg in the mixed reality device by at least one of a mechanical, a magnetic, or a chemical fitting;
a cord separating the first connector from the second connector by an adjustable distance greater than a circumference of a user body part; and
a lanyard circuit configured to transmit a power or a digital signal between the mixed reality device and the lanyard through the first connector or the second connector, wherein:
the cord comprises an energy transfer component providing one of a digital signal to a processor in the mixed reality device, or the power from the lanyard circuit to the processor of the mixed reality device.

12. The mixed reality device of claim 11, wherein the one or more digital glasses comprise a display to provide a digital vision correction to the user, wherein the digital vision correction comprises adjusting an optical feature of the one or more digital glasses to a position based on a vision prescription for a user of the mixed reality device.

13. The mixed reality device of claim 11, wherein the one or more digital glasses provide a digitally enhanced audio signal to the user.

14. The mixed reality device of claim 11, wherein the lanyard further comprises one of:
a haptic sensor configured to provide a posture information to the processor circuit, and the processor circuit is configured to provide a posture recommendation to a user via the one or more digital glasses,
a health sensor to monitor a vital sign of the user, or
a chemical sensor to detect a chemical substance in a user environment or clothes.

15. The mixed reality device of claim 11, wherein the lanyard further comprises an inertial measurement unit configured to measure an acceleration of the lanyard and provide the acceleration of the lanyard to the processor circuit, and the processor circuit is configured to shut the mixed reality device down when a fall is detected.

16. The mixed reality device of claim 11, wherein the cord is configured to hold the mixed reality device to a user's neck, the lanyard further comprising a back looking camera, the digital signal comprises a back view for a user, and the processor circuit is configured to provide the back view in the one or more digital glasses.

17. The mixed reality device of claim 11, further comprising a microphone and the digital signal comprises a background sound for a user, and wherein the processor circuit is configured to provide a stereophonic sound to the user based on the background sound.

18. The mixed reality device of claim 11, wherein the lanyard further comprises one of:
a back display, and wherein the processor circuit is configured to provide a partial view of a user's display to the back display, or
a rear view camera configured to capture a rear view for a user, and wherein the processor circuit is configured to provide the rear view to the one or more digital glasses.

19. The mixed reality device of claim 11, wherein at least one of the digital glasses includes a back viewing camera to capture an eye motion of a user, and the processor circuit is configured to: determine a focus of attention of the user based on the eye motion, and provide to a back display in the lanyard an indication of an intended direction of the user for an observer at the back of the user.

20. The mixed reality device of claim 11, further comprising a microphone and the digital signal comprises a background sound, and wherein the processor circuit is configured to provide a stereophonic sound signal to a speaker for a user, based on the background sound.
